(19) United States
(12) Patent Application Publication
(10) Pub. No.: US 2009/0119931 A1
(43) Pub. Date: May 14, 2009

(54) TOOL ELEMENT AND MARKING SYSTEM

(76) Inventor: Andrew G. Gongola, Menomonee Falls, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/354,110

(22) Filed: Jan. 15, 2009

Related U.S. Application Data
(63) Continuation of application No. 10/422,175, filed on Apr. 24, 2003, now abandoned.
(60) Provisional application No. 60/375,932, filed on Apr. 26, 2002.

(51) Int. Cl. B26B 29/06; B26B 9/02

(52) U.S. Cl. 30/286; 30/355

(57) ABSTRACT

A reciprocating saw blade for use with a reciprocating saw having a movable shoe includes a main body including a first end configured to attach to the reciprocating saw, a first edge, and a second edge opposite the first edge. The main body includes a plurality of coarse teeth and a plurality of fine teeth defined in the first edge, the coarse teeth extending along a length in the first edge near a center of the main body and the fine teeth being defined in the first edge on both sides of the coarse teeth. A first indicator is positioned on the main body adjacent the first edge and substantially aligned with a center of the length to indicate the center of the coarse teeth and a plurality of second indicators is positioned on the main body adjacent the second edge. Each of the plurality of second indicators is spaced a different distance from the first indicator than any of the other of the plurality of second indicators. Each distance corresponds to a size of a workpiece. Each of the plurality of second indicators is positioned between the first indicator and the first end such that no indicators are positioned on the side of the first indicator opposite the first end. Alignment of the shoe with any one of the plurality of second indicators aligns the first indicator with a center of a workpiece having a size corresponding to the selected one of the plurality of second indicators.

### RELATED APPLICATIONS

The present application is a continuation application of U.S. patent application Ser. No. 10/422,175, now abandoned which claims the benefit of prior-filed, co-pending provisional patent application Ser. No. 60/375,932, filed Apr. 26, 2002.

### FIELD OF THE INVENTION

The invention relates to tools and, more particularly, to tool elements, such as, for example, saw blades and drill bits.

### BACKGROUND

Power tools, such as reciprocating saws, circular saws, and drills, utilize tool elements, such as reciprocating saw blades, circular saw blades, and drill bits, respectively, therewith to perform an operation, such as sawing or drilling, on a workpiece. It is desirable to properly position the tool element relative to the workpiece so that the operation is performed with the greatest efficiency. Typically, an operator guesses at the proper position of the tool element relative to the workpiece or “eyes-up” the tool element with the workpiece. By using these positioning procedures, the tool element is often not properly positioned relative to the workpiece to perform the operation with the greatest efficiency.

### SUMMARY

Existing tools, such as power tools and hand held tools, typically use tool elements, such as, for example, saw blades and drill bits, to perform operations, such as cutting, boring, and drilling, on workpieces. Due to the size, shape, and/or material of the workpiece, the operation may need to be performed on the workpiece in a particular manner. In some instances, the tool element may need to be properly aligned with the workpiece to perform an efficient operation, or a portion of the tool, such as a guide or shoe, may need to be aligned with the workpiece to perform an efficient operation.

With existing tool elements and tools, an operator must guess or visually line-up the tool element or portion of the tool with the workpiece. This procedure often results in inefficient operations due to the improper alignment of the tool element and/or tool with the workpiece. For example, a saw blade must be properly aligned with a workpiece when the workpiece is a tubular material in which a combination of thin and thick material cross-sections is encountered. Saw blades that cut tubular workpieces have a combination of coarse and fine teeth defined in an edge thereof for cutting the thick and thin material cross-sections, respectively. An operator must guess or visually line-up the coarse and fine teeth with the thick and thin cross-sections of the tubular material. This procedure often results in inefficient operations.

The present invention provides a tool element which alleviates one or more independent problems with existing tool elements and tools. In some aspects and in some constructions, the invention provides a tool element that communicates to an end user the ideal alignment of a tool element with a workpiece in order to perform an efficient operation.

More particularly, in some aspects and in some constructions, the invention provides a tool element generally including a main body and an indicator positioned on the main body for indicating the position of the tool element relative to a workpiece.

In some constructions, the indicator may correspond to a property of the tool element. In other constructions, the indicator may correspond to a property of the workpiece. In further constructions, the indicator may correspond to a type of workpiece material the tool element can perform work upon. In additional constructions, the indicator may indicate a depth into the workpiece that the tool element extends during operation.

In some constructions, the tool element may be a reciprocating saw blade. In other constructions, the tool element may be a circular saw blade. In further embodiments, the tool element may be a drill bit.

Also, in some aspects and in some constructions, the invention provides a tool element for use with a power tool, which has a guide. The tool element generally includes a main body connectable to the power tool and an indicator positioned on the main body for indicating the position of the guide relative to the workpiece

In some constructions, the indicator may correspond to a property of the workpiece. In other constructions, the indicator may correspond to a diameter of the work piece and the guide may be positionable at the indicator to position the guide relative to the workpiece and facilitate work to be performed on the workpiece by the tool element and the power tool. In further constructions, the indicator may correspond to a width of the workpiece and the guide may be positionable at the indicator to position the guide relative to the workpiece and facilitate work to be performed on the workpiece by the tool element and the power tool. In additional constructions, the indicator may correspond to a cutting depth into the work piece and the guide may be positionable at the indicator to position the guide relative to the workpiece and facilitate cutting of the workpiece to the cutting depth by the tool element and the power tool.

In some constructions, the tool element may be a reciprocating saw blade and the power tool is a reciprocating saw. In other constructions, the tool element may be a circular saw blade and the power tool may be a circular saw. In further constructions, the tool element may be a drill bit and the power tool may be a drill.

Further, in some aspects and in some constructions, the invention provides a method of manufacturing a tool element. The method includes providing the tool element and producing an indicator on the tool element for indicating the position of the tool element relative to a workpiece.

In one construction, the invention provides a combination that includes a reciprocating saw including a housing, a motor supported by the housing, and a movable saw shoe supported by the housing. A reciprocating saw blade includes a main body having a first end connectable to the reciprocating saw and a plurality of teeth extending along a length of an edge thereof. A center indicator is positioned on the main body to indicate a point at about the center of the length of the edge. A first indicator is positioned on the main body and spaced a first distance from the center indicator, the first distance corresponding to a size of a first workpiece. A second indicator is positioned on the main body and is spaced a second distance from the center indicator. The second distance is different than the first distance and corresponds to a size of a second workpiece. The saw shoe aligns with the first indicator to position the center indicator along a centerline of the first workpiece when the shoe abuts the first workpiece and the size of the first workpiece corresponds to the first distance. The saw shoe aligns with the second indicator to position the center indicator along a centerline of the second workpiece when the shoe abuts the second workpiece and the size of the second workpiece corresponds to the second distance.

In another construction, the invention provides a reciprocating saw blade for use with a reciprocating saw. The reciprocating saw includes a saw shoe. The reciprocating saw blade includes a main body having a first end configured to connect to the reciprocating saw. The main body includes coarse teeth extending along a first portion of an edge and fine teeth extending along a second portion of the edge. A first indicator is positioned on the main body adjacent the coarse teeth at about the center of the first portion. The first indicator indicates the center of the saw blade. A second indicator is positioned on the main body, spaced a first distance from the first indicator, and positioned between the first indicator and the first end. The first distance corresponds to a size of a workpiece. The saw shoe is positionable adjacent the second indicator to abut the saw shoe against the workpiece and to position the first indicator along a centerline of the workpiece, the centerline being substantially perpendicular to the edge.

In yet another construction, the invention provides a reciprocating saw blade for use with a reciprocating saw having a movable shoe. The saw blade includes a main body including a first end configured to attach to the reciprocating saw, a first edge, and a second edge opposite the first edge. The main body includes a plurality of coarse teeth and a plurality of fine teeth defined in the first edge, the coarse teeth extending along a length in the first edge near a center of the main body and the fine teeth being defined in the first edge on both sides of the coarse teeth. A first indicator is positioned on the main body adjacent the first edge and substantially aligned with a center of the length to indicate the center of the coarse teeth and a plurality of second indicators is positioned on the main body adjacent the second edge. Each of the plurality of second indicators is spaced a different distance from the first indicator than any of the other of the plurality of second indicators. Each distance corresponds to a size of a workpiece. Each of the plurality of second indicators is positioned between the first indicator and the first end such that no indicators are positioned on the side of the first indicator opposite the first end. Alignment of the shoe with any one of the plurality of second indicators aligns the first indicator with a center of a workpiece having a size corresponding to the selected one of the plurality of second indicators.

Independent features and independent advantages of the present invention will become apparent to those skilled in the art upon review of the following detailed description, claims and drawings.

### BRIEF DESCRIPTION OF THE DRAWING

FIG. 1 is a side view of a power tool, such as a reciprocating saw, including a saw blade embodying aspects of the present invention.

FIG. 2 is a side view of the saw blade illustrated in FIG. 1, shown with a workpiece.

FIG. 3 is a partial side view of a first alternate construction of the saw blade illustrated in FIGS. 1 and 2.

FIG. 4 is a partial side view of a second alternate construction of the saw blade illustrated in FIGS. 1 and 2.

FIG. 5 is a partial side view of a third alternate construction of the saw blade illustrated in FIGS. 1 and 2.

FIG. 6 is a partial side view of a fourth alternate construction of the saw blade illustrated in FIGS. 1 and 2.

FIG. 7 is a partial side view of a fifth alternate construction of the saw blade illustrated in FIGS. 1 and 2.

FIG. 8 is a side view of a power tool, such as a circular saw, and a saw blade embodying aspects of the present invention.

FIG. 9 is a partial side view of the saw blade illustrated in FIG. 8.

FIG. 10 is a side view of a drill bit embodying aspects of the present invention.

Before at least one embodiment of the invention is explained in detail, it is to be understood that the invention is not limited in its application to the details of the constructions and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

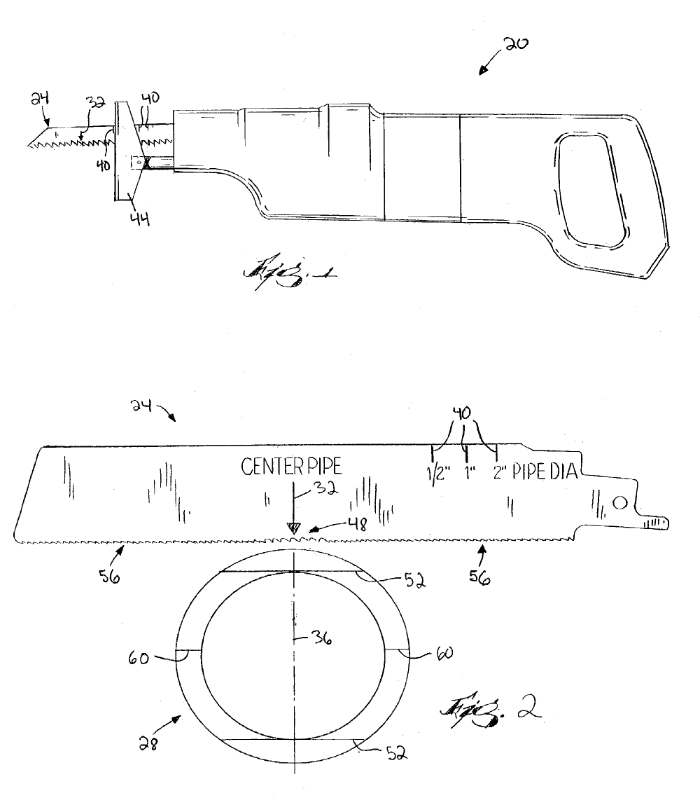

FIG. 1 illustrates a power tool, such as an electric-powered reciprocating saw 20, and a tool element, such as a reciprocating saw blade 24, embodying aspects of the present invention. The electric-powered reciprocating saw 20 is similar to electric-powered reciprocating saws, such as those described in U.S. Pat. Nos. 6,212,781 and 6,249,979, which are hereby incorporated by reference. Although a power tool is described and illustrated, the tool element can be used with other types of tools that are not powered, such as manual hand saws, and still be within the spirit and scope of the present invention.

The saw blade 24 and reciprocating saw 20 operate in combination to perform a reciprocating sawing operation. The reciprocating saw 20 reciprocates the saw blade 24 through a cutting stroke, from an extended position (to the left in FIG. 1) to a retracted position (to the right in FIG. 1), and through a return stroke from the retracted position to the extended position. In between the extended and retracted positions, the saw blade 24 is positioned in a mid-stroke position.

The saw blade 24 includes a marking system for indicating to an operator the proper alignment of the saw blade 24 relative to a workpiece 28 for most efficient cutting in the reciprocating sawing operation. The saw blade 24 includes a workpiece indicator 32, which is alignable with a portion of the workpiece 28, such as the center 36, and shoe position indicators 40, which indicate selected positions of the workpiece guide, such as a reciprocating saw shoe 44. The workpiece indicator 32 and the shoe position indicators 40 can correspond to properties of the workpiece 28, such as, for example, the diameter of a circular workpiece 28, the width of a workpiece 28, the material of the workpiece 28, and the cutting depth into the workpiece 28, or correspond to properties of the saw blade 24, such as, for example the coarseness or fineness of the teeth, the type of saw blade 24, and the stroke length of the saw blade 24. The indicators 32 and 40 may be stamped, punched, carved, painted or otherwise formed on the saw blade 24.

In the construction illustrated in FIG. 2, the saw blade 24 is configured to cut a hollow, cylindrical workpiece 28, such as a pipe. To provide efficient cutting, the saw blade 24 also includes a central set of coarse teeth 48, for cutting the thick cross-section 52 of the center 36 of the workpiece 28 at the start and end of the cutting operation, and two sets of fine teeth 56, for cutting the outer thin cross-sections 60 of the workpiece 28. Such a combination of sets of coarse teeth 48 and fine teeth 56 increase the cutting efficiency of saw blades for pipe cutting operations as described in U.S. Pat. No. 3,805,383, which is hereby incorporated by reference. However, the saw blade illustrated in U.S. Pat. No. 3,805,383 does not include any indications as to the proper positioning of the saw blade relative to the pipe to achieve the efficient cutting benefits of the saw blade design.

In the construction illustrated in FIG. 2, the reciprocating saw shoe 44 is aligned with the selected shoe position indicator 40 corresponding to the diameter of the workpiece 28. The coarse teeth 48 are defined substantially beneath and on both sides of the workpiece indicator 32, and the indicator 32 is preferably aligned with the center 36 of the workpiece 28 when the saw blade 24 is in the mid-stroke position to start cutting.

As the saw blade 24 is reciprocated, the set of coarse teeth 48 cut the thick-cross section 52. The sets of fine teeth 56 are positioned on both sides of the coarse teeth 48 and cut respective outer thin cross-sections 60. Finally, the set of coarse teeth 48 cuts the opposite thick cross-section 52 to complete cutting of the workpiece 28.

Referring to FIG. 3, a first alternate construction of the saw blade 24 is illustrated. With some exceptions (described in greater detail below), the saw blade 24 illustrated in FIG. 3 is similar to the saw blade 24 described above with reference to FIGS. 1-2. Accordingly, reference is made to the above discussion regarding the structure, operation, and alternatives of the saw blade 24 illustrated in FIG. 3, wherein like elements and features of the saw blade 24 illustrated in FIG. 3 have like reference numerals.

In the construction illustrated in FIG. 3, the saw blade 24 is configured to cut a hollow, cylindrical workpiece 28, such as a pipe, similar to the construction of the saw blade 24 illustrated in FIG. 2. Accordingly, the saw blade 24 includes coarse teeth 48 and two sets of fine teeth 56. In the construction illustrated in FIG. 3, the saw blade 24 includes a coarse teeth indicator 64, such as the letter “C”, substantially positioned over the center of the coarse teeth 48 and a plurality of fine teeth indicators 68, such as the letter “F”, one of which is substantially positioned over the center of each set of fine teeth 56. The coarse teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

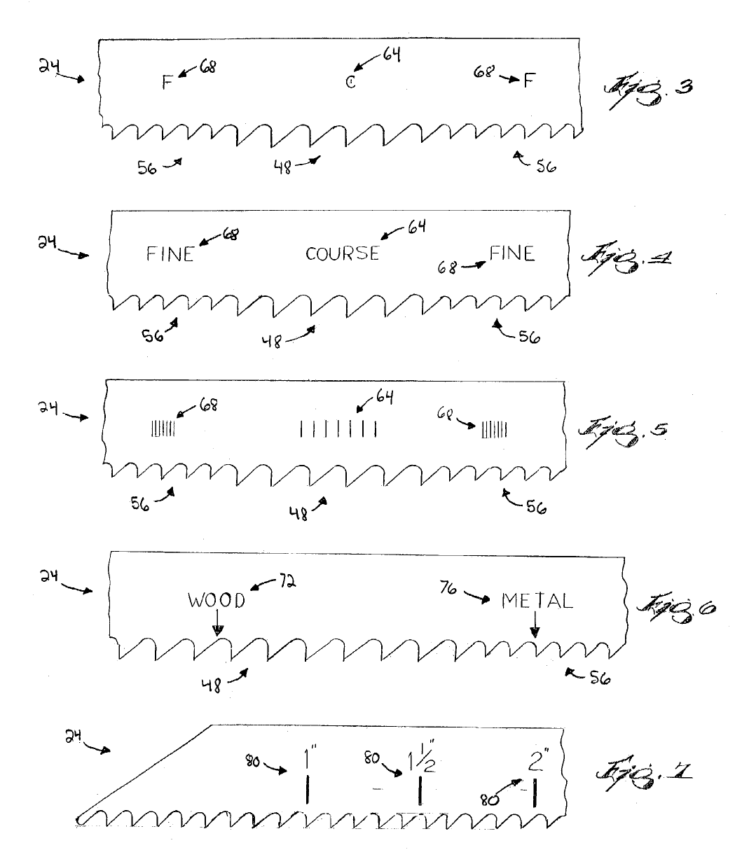

Referring to FIG. 4, a second alternate construction of the saw blade 24 is illustrated. With some exceptions (described in greater detail below), the saw blade 24 illustrated in FIG. 4 is similar to the saw blades 24 described above with reference to FIGS. 1-3. Accordingly, reference is made to the above discussion regarding the structure, operation, and alternatives of the saw blade 24 illustrated in FIG. 4, wherein like elements and features of the saw blade 24 illustrated in FIG. 4 have like reference numerals.

In the construction illustrated in FIG. 4, the saw blade 24 is configured to cut a hollow, cylindrical workpiece 28, such as a pipe, similar to the saw blade 24 constructions illustrated in FIGS. 2-3. Accordingly, the saw blade 24 includes coarse teeth 48 and two sets of fine teeth 56. In the construction illustrated in FIG. 4, the saw blade 24 includes a coarse teeth indicator 64, such as the word “COARSE”, substantially positioned over the center of the coarse teeth 48 and a plurality of fine teeth indicators 68, such as the word “FINE”, one of which is substantially positioned over the center of each set of fine teeth 56. The coarse teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

Referring to FIG. 5, a third alternate construction of the saw blade 24 is illustrated. With some exceptions (described in greater detail below), the saw blade 24 illustrated in FIG. 5 is similar to the saw blades 24 described above with reference to FIGS. 1-4. Accordingly, reference is made to the above discussion regarding the structure, operation, and alternatives of the saw blade 24 illustrated in FIG. 5, wherein like elements and features of the saw blade 24 illustrated in FIG. 5 have like reference numerals.

In the construction illustrated in FIG. 5, the saw blade 24 is configured to cut a hollow, cylindrical workpiece 28, such as a pipe, similar to the saw blade 24 constructions illustrated in FIGS. 2-4. Accordingly, the saw blade 24 includes coarse teeth 48 and two sets of fine teeth 56. In the construction illustrated in FIG. 5, the saw blade 24 includes a coarse teeth indicator 64, such as a plurality of substantially parallel vertical lines spaced a first distance from one another, substantially positioned over the center of the coarse teeth 48 and extending toward the ends of the set of coarse teeth 48. The saw blade 24 also includes a plurality of fine teeth indicators 68, such as a plurality of substantially parallel vertical lines spaced a second distance from one another. In the construction illustrated in FIG. 5, the first distance is greater than the second distance. Each fine teeth indicator 68 is substantially positioned over the center of each set of fine teeth 56 and extends toward the ends of the sets of fine teeth 56. The coarse teeth indicator 64 is positionable over the thick cross-section 52 of the workpiece 28 and the fine teeth indicators 68 are positionable over the thin cross-sections 60 of the workpiece 28. As the saw blade 24 is reciprocated, the workpiece 28 is cut in a manner similar to that described above with reference to the construction illustrated in FIG. 2.

It should be understood that the coarse teeth indicators 64 and the fine teeth indicators 68 can take other shapes and forms from those constructions described above with reference to FIGS. 1-5. Accordingly, coarse teeth indicators 64 and fine teeth indicators 68 can take any shape or form to indicate the position of coarse teeth 48 and fine teeth 56, respectively, and therefore, indicate the proper position of the saw blade 24 relative to the workpiece 28.

It should also be understood that the saw blade 24 and power tool, such as the reciprocating saw 20, can be configured to cut other workpieces 28, such as hollow square tubing and hollow rectangular tubing, having thick cross-sections and thin cross-sections for coarse teeth 48 and fine teeth 56 to cut respectively, or solid workpieces, such as solid pipes, solid boards, and solid rods.

Referring to FIG. 6, a fourth alternate construction of the saw blade 24 is illustrated. With some exceptions (described in greater detail below), the saw blade 24 illustrated in FIG. 6 is similar to the saw blades 24 described above with reference to FIGS. 1-5. Accordingly, reference is made to the above discussion regarding the structure, operation, and alternatives of the saw blade 24 illustrated in FIG. 6, wherein like elements and features of the saw blade 24 illustrated in FIG. 6 have like reference numerals.

In the construction illustrated in FIG. 6, the saw blade 24 is configured to cut multiple types of workpieces 28 having multiple materials, such as wood, metal, and plastic. The saw blade 24 includes multiple types of teeth, such as coarse teeth 48 and fine teeth 56, corresponding to the type of material to be cut by the teeth. The saw blade 24 can include any number of varying types of teeth to cut any number of varying types of material. In the construction illustrated in FIG. 6, the saw blade 24 includes a set of coarse teeth 48 for cutting workpieces 28 made of wood and a set of fine teeth 56 for cutting workpieces 28 made of metal. The saw blade 24 also includes a first material indicator 72, such as the word “WOOD” and a substantially vertical downward pointing arrow, substantially positioned over the center of the coarse teeth 48 for indicating the teeth to be used when performing cutting operations on workpieces 28 made of wood, and a second material indicator 76, such as the word “METAL” and a substantially vertical downward pointing arrow, substantially positioned over the center of the fine teeth 56 for indicating the teeth to be used when performing cutting operations on workpieces 28 made of metal. Accordingly, cutting operations are properly performed with increased efficiency by positioning the appropriate teeth of the saw blade 24, via the material indicators 72, 76, relative to the workpiece 28 to be cut.

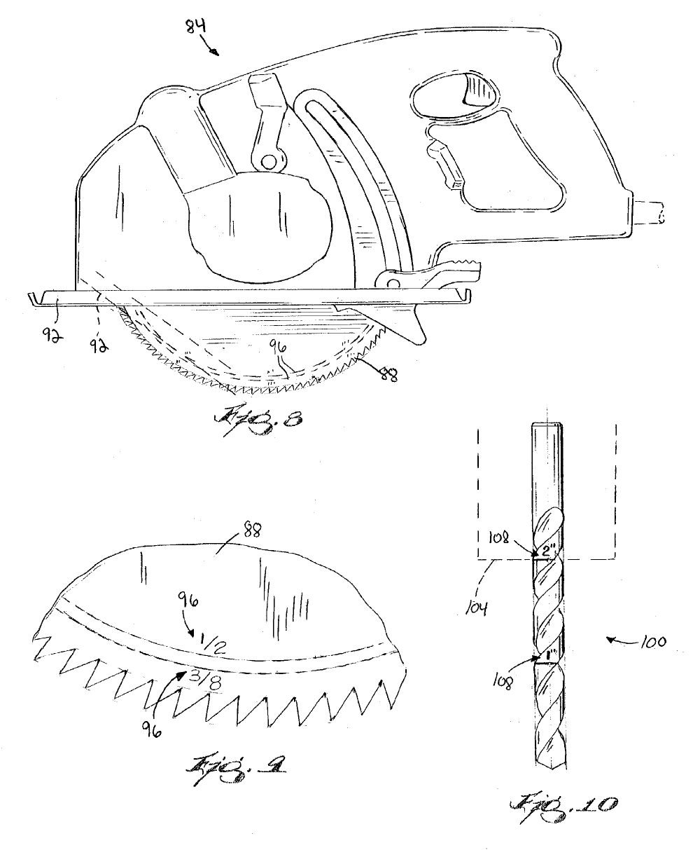

Referring to FIG. 7, a fifth alternate construction of the saw blade 24 is illustrated. With some exceptions (described in greater detail below), the saw blade 24 illustrated in FIG. 7 is similar to the saw blades 24 described above with reference to FIGS. 1-6. Accordingly, reference is made to the above discussion regarding the structure, operation, and alternatives of the saw blade 24 illustrated in FIG. 7, wherein like elements and features of the saw blade 24 illustrated in FIG. 7 have like reference numerals.

In the construction illustrated in FIG. 7, the saw blade 24 is configured to cut a variety of workpieces 28 and to position the saw blade 24 relative to the workpieces 28. The saw blade 24 also includes a plurality of cutting depth indicators 80 to indicate a cutting depth of the saw blade 24. The cutting depth indicators 80 are spaced from one another at any appropriate increment, such as by quarter inches, half inches, inches, or any other appropriate English or metric increments. In the construction illustrated in FIG. 7, the saw blade 24 includes three cutting depth increments, such as “1″”, “1½″”, and “2″”, spaced at half inch increments.

The workpiece 28 can be cut at one of the desired depths in a variety of manners. An operator can position the desired cutting depth indicator 80 at an edge of a workpiece 28 with the portion of the saw blade 24 between the desired cutting depth indicator 80 and the tip of the saw blade 24 positioned over the workpiece 28. The operator can then manually move the saw blade 24 through the workpiece 28 and manually maintain alignment of the desired cutting depth indicator 80 with the edge of the workpiece 28. Alternatively, the shoe 44 of the reciprocating saw 20 can be aligned with the desired cutting depth indicator 80 and the shoe 44 can be pressed against the edge of the workpiece 28. The operator can then move the saw blade 24 through the workpiece 28 while maintaining contact between the shoe 44 and the edge of the workpiece 28. This ensures that the workpiece 28 is cut with a substantially uniform cutting depth throughout.

It should be understood that the saw blade 24 described above with reference to FIG. 7 can include any number of cutting depth indicators 80 and can have any increment of spacing between the cutting depth indicators 80. Accordingly, the cutting depth indicators 80 and increments described above and illustrated in FIG. 7 are for exemplary purposes only.

It should also be understood that, in other constructions (not shown), the indicators 32, 40, 64, 68, 72, 76, 80 may be used to indicate different properties, such as the proper cutting alignment of the saw blades 24 when the saw blades 24 are in the extended or retracted position.

It should further be understood that, in other constructions (not shown), the indicator 32, 40, 64, 68, 72, 76, 80 may be used to indicate different properties, such as, for example, the selected stroke length of the saw blades 24.

FIG. 8 illustrates a power tool, such as an electric-powered circular saw 84, and a tool element, such as a circular saw blade 88, embodying aspects of the present invention. The electric-powered circular saw 84 is similar to the electric-powered circular saw described in U.S. Pat. No. 6,301,789, which is hereby incorporated by reference.

The saw blade 88 and circular saw 84 operate in combination to perform a circular sawing operation. The saw blade 88 includes a plurality of teeth defined in a perimeter thereof and is rotatable by the circular saw 84 to cut a workpiece 28 positioned underneath a guide or shoe 92 of the circular saw 84. The circular saw 84 is advanced along a workpiece 28 and the shoe 92 slides along the top of the workpiece 28 to provide vertical support to the circular saw 84.

In the construction illustrated in FIGS. 8-9, the saw blade 88 includes a marking system for indicating to an operator the proper alignment of the saw blade 88 relative to the workpiece 28 for uniform cutting depth in the circular cutting operation. The saw blade 88 includes a plurality of cutting depth indicators 96 concentrically disposed around the saw blade 88 and incrementally spaced from one another. In the construction illustrated in FIGS. 8-9, the cutting depth indicators 96 are disposed on the saw blade 88 to facilitate a three-eighths inch cut and a half inch cut in a workpiece 28 and are incrementally spaced one-eighth of an inch from one another.

To perform a cutting operation at a desired cutting depth, the saw blade 88 is positioned in the circular saw 84 so that the bottom surface (or surface that is engageable with the workpiece 28) of the shoe 92 is substantially tangential to the desired cutting depth indicator 96. In other words, the desired cutting depth indicator 96 will not substantially extend below the bottom surface of the shoe 92 when the desired cutting depth indicator 96 and the shoe 92 are properly aligned.

It should be understood that the saw blade 88 described above with reference to FIGS. 8-9 can include any number of cutting depth indicators 96 and can have any increment of spacing between the cutting depth indicators 96, including both English and metric increments.

It should also be understood that the saw blade 88 described above with reference to FIGS. 8 and 9 can include other indicators that correspond to things other than cutting depth. These other indicators can correspond to properties of the workpiece 28, such as, for example, the diameter of a circular workpiece 28, the width of a workpiece 28, and the material of the workpiece 28, or correspond to properties of the saw blade 24, such as, for example the coarseness or fineness of the teeth, the type of saw blade 24, and the stroke length of the saw blade 24.

FIG. 10 illustrates a tool element, such as a drill bit 100, embodying aspects of the present invention. The drill bit 100 is operable in combination with a drill, such as a manual drill and an electric-powered drill (not shown), such as those described in U.S. Pat. Nos. 6,102,633, 4,682,918 and 4,229,981, which are hereby incorporated by reference. The drill includes a chuck 104 (shown in phantom in FIG. 10), which is operable to connect the drill bit 100 to the drill.

The drill bit 100 and drill operate in combination to perform a boring or drilling operation. The drill rotates the drill bit 100 to cut or bore a hole in a workpiece 28 and is advanced to bore deeper into the workpiece 28 by applying a force on the drill in the desired advancing direction.

In the construction illustrated in FIG. 10, the drill bit 100 includes a marking system for indicating to an operator the proper alignment of the drill bit 100 relative to the workpiece 28 and the drill. The marking system also assists in producing uniform bore depths during drilling operations. The drill bit 100 includes a plurality of boring depth indicators 108 incrementally spaced from one another. In the construction illustrated in FIG. 10, the boring depth indicators 108 are disposed on the drill bit 100 to facilitate a one inch bore and a two inch bore in a workpiece 28 and are incrementally spaced one inch from one another.

To perform a boring operation at a desired boring depth, the drill bit 100 is connected to the chuck 104 by inserting the drill bit 100 into the chuck 104 until the desired boring depth indicator 108 is aligned with the outermost surface of the chuck 104 (as shown in phantom in FIG. 10). The chuck 104 is then tightened around the drill bit 100 to secure the drill bit 100 to the drill. Alternatively, the drill can include a depth locator or other device (not shown) surrounding the drill bit 100 and extending toward the tip of the drill bit 100. The depth locator is aligned with the desired boring depth indicator 108 rather than the chuck 104. The drill bit 100 is biased against a workpiece 28 and appropriately bores into the workpiece 28 until the outermost surface of the chuck 104 or the depth locator engages the workpiece 28. Upon engagement between the chuck 104 or depth locator and the workpiece 28, a bore is bored into the workpiece 28 by the drill bit 100 to the desired boring depth. An operator can alternatively visually inspect the boring operation and terminate the boring operation when the desired boring depth indicator 108 is flush with the surface of the workpiece 28.

It should be understood that the drill bit 100 described above with reference to FIG. 10 can include any number of boring depth indicators 108 and can have any increment of spacing between the boring depth indicators 108, including both English and metric increments.

It should also be understood that the drill bit 100 described above with reference to FIG. 10 can include other indicators that correspond to things other than boring depth. These other indicators can correspond to properties of the workpiece 28, such as, for example, the diameter of a circular workpiece 28, the width of a workpiece 28, and the material of the workpiece 28, or correspond to properties of the drill bit 100, such as, for example the size of the drill bit 100 and the type of drill bit 100.

In addition, it should be understood that, in other constructions (not shown), additional indicators (not shown) may be provided to indicate different conditions as necessary for a given operation, whether the operation be cutting, drilling, or any other operation performed by a power tool.

Although particular constructions of the present invention have been shown and described, other alternate constructions will be apparent to those skilled in the art and are within the intended scope of the present invention. Thus, the present invention is to be limited only by the claims.

What is claimed is:

1. A combination comprising:
a reciprocating saw including a housing, a motor supported by the housing, and a movable saw shoe supported by the housing;
a reciprocating saw blade including a main body having a first end connectable to the reciprocating saw and a plurality of teeth extending along a length of an edge thereof;
a center indicator positioned on the main body to indicate a point at about the center of the length of the edge;
a first indicator positioned on the main body and spaced a first distance from the center indicator, the first distance corresponding to a size of a first workpiece; and
a second indicator positioned on the main body and spaced a second distance from the center indicator, the second distance being different than the first distance and corresponding to a size of a second workpiece;
wherein the saw shoe aligns with the first indicator to position the center indicator along a centerline of the first workpiece when the shoe abuts the first workpiece and the size of the first workpiece corresponds to the first distance, and wherein the saw shoe aligns with the second indicator to position the center indicator along a centerline of the second workpiece when the shoe abuts the second workpiece and the size of the second workpiece corresponds to the second distance.

2. The combination of claim 1, wherein the first size is a first diameter and the second size is a second diameter different than the first diameter, the saw shoe being selectively alignable with either the first indicator or the second indicator to accommodate a workpiece having a size equal to either the first diameter or the second diameter, respectively.

3. The combination of claim 1, wherein the first size is a first width and the second size is a second width different than the first width, the saw shoe being selectively alignable with either the first indicator or the second indicator to accommodate a workpiece having a size equal to either the first width or the second width, respectively.

4. The combination of claim 1, wherein the first indicator and the second indicator are located between the center indicator and the first end.

5. The combination of claim 4, wherein no indicators are positioned on the side of the center indicator opposite the first end.

6. The combination of claim 1, wherein the center indicator includes an arrowhead positioned adjacent the edge.

7. The combination of claim 6, wherein the first indicator and the second indicator are positioned adjacent a second edge opposite the edge including the coarse teeth.

8. The combination of claim 6, wherein the plurality of teeth includes a first region of fine teeth, a second region of fine teeth, and a region of coarse teeth positioned between the first region and the second region such that the center of the length of the edge is disposed at about the center of the region of coarse teeth.

9. A reciprocating saw blade for use with a reciprocating saw, the reciprocating saw including a saw shoe, the reciprocating saw blade comprising:
a main body including a first end configured to connect to the reciprocating saw, the main body including coarse teeth extending along a first portion of an edge and fine teeth extending along a second portion of the edge;
a first indicator positioned on the main body adjacent the coarse teeth at about the center of the first portion, the first indicator indicating the center of the saw blade; and
a second indicator positioned on the main body, spaced a first distance from the first indicator, and positioned between the first indicator and the first end, the first distance corresponding to a size of a workpiece such that the saw shoe is positionable adjacent the second indicator to abut the saw shoe against the workpiece and to position the first indicator along a centerline of the workpiece, the centerline being substantially perpendicular to the edge.

10. The reciprocating saw blade of claim 9, wherein the coarse teeth are defined near a center of the main body and the fine teeth are defined on both sides of the coarse teeth, and wherein the first indicator is positioned on the main body in alignment with the coarse teeth.

11. The reciprocating saw blade of claim 9, wherein the edge defining the plurality of teeth is a first edge of the main body, and wherein the second indicator is positioned adjacent a second edge of the reciprocating saw opposite the first edge.

12. The reciprocating saw blade of claim 9, wherein the first indicator includes an arrowhead positioned adjacent the edge to indicate the center of the coarse teeth.

13. The reciprocating saw blade of claim 9, wherein the second indicator is one of a plurality of second indicators each spaced a different distance from the first indicator.

14. The reciprocating saw blade of claim 13, wherein none of the plurality of second indicators are positioned on the side of the first indicator opposite the first end.

15. The reciprocating saw blade of claim 13, wherein each of the plurality of second indicators are positioned on a side of the main body opposite the edge that includes the coarse teeth.

16. The reciprocating saw blade of claim 9, wherein the plurality of fine teeth includes a first portion of fine teeth and a second portion of fine teeth, the plurality of coarse teeth being positioned between the first portion of fine teeth and the second portion of fine teeth.

17. A reciprocating saw blade for use with a reciprocating saw having a movable shoe, the saw blade comprising:
a main body including a first end configured to attach to the reciprocating saw, a first edge, and a second edge opposite the first edge, the main body having a plurality of coarse teeth and a plurality of fine teeth defined in the first edge, the coarse teeth extending along a length in the first edge near a center of the main body and the fine teeth being defined in the first edge on both sides of the coarse teeth;
a first indicator positioned on the main body adjacent the first edge and substantially aligned with a center of the length to indicate the center of the coarse teeth;
a plurality of second indicators positioned on the main body adjacent the second edge, each of the plurality of second indicators spaced a different distance from the first indicator than any of the other of the plurality of second indicators, each distance corresponding to a size of a workpiece, each of the plurality of second indicators positioned between the first indicator and the first end such that no indicators are positioned on the side of the first indicator opposite the first end, wherein alignment of the shoe with any one of the plurality of second indicators aligns the first indicator with a center of a workpiece having a size corresponding to the selected one of the plurality of second indicators.

18. The reciprocating saw blade of claim 17, wherein the first indicator includes an arrowhead positioned adjacent the coarse teeth.

19. The reciprocating saw blade of claim 18, wherein the distance between the first indicator and each of the plurality of second indicators corresponds to a radius of a workpiece.

20. The reciprocating saw blade of claim 17, wherein each of the plurality of second indicators includes a label that is indicative of a diameter of the workpiece to which the particular indicator corresponds.
